(19) United States
(12) Patent Application Publication
(10) Pub. No.: US 2005/0156346 A1
(43) Pub. Date: Jul. 21, 2005

(54) Method for fabricating mold core

(75) Inventors: Tai-Cherng Yu, Tu-Cheng (TW); Ga-Lane Chen, Fremont, CA (US); Charles Leu, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/025,806

(22) Filed: Dec. 29, 2004

(30) Foreign Application Priority Data
Jan. 16, 2004 (TW) 93101188

(51) Int. Cl. B29C 33/40

(52) U.S. Cl. 264/102; 264/219

(57) ABSTRACT

A method for fabricating a mold core (30) includes the following steps: mixing a silicone elastomer with a curing agent (S901); defoaming bubbles of the mixture (S902); forming a layer (10) of the mixture on a substrate (20) having a predetermined surface structure formed thereon (S903); curing the layer of the mixture (S904); and separating the cured layer from the substrate to provide the mold core (S905). Unlike in the prior art, there is no need for steps of forming a photo-resist pattern, forming a Cu layer, and/or etching the Cu layer off. Thus, the method of the present invention has reduced complexity and costs compared with the method of the prior art. In addition, the obtained structure of the mold core corresponds more closely to the predetermined structure of the substrate. That is, the precision of the mold core is significantly increased.

### BACKGROUND OF THE INVENTION

1. Field of the Invention

The present invention relates to methods for fabricating mold cores, and particularly to a method for fabricating a hot embossing mold core.

2. Description of the Prior Art

In mold core fabrication, two methods are widely used; namely, machining and chemical etching. The machining method is relatively easy to perform and costs less, and is therefore commonly used to manufacture low end products that require only low precision. Precision machining can be performed to attain high levels of quality. However, the process is correspondingly costly.

In the chemical etching method, firstly, patterns are formed on the surface of a base plate. Then the base plate is etched using a chemical solution in order to form a desired structure. Anisotropic chemical etching is frequently needed to manufacture a mold core for precision equipment such as a light guide plate (for a liquid crystal display), an MEMS (micro-electro-mechanical system), or a biological chip. However, the direction of etching cannot be reliably controlled. The fabricated mold core often needs repeated modification, which expends additional time and money.

Referring to FIG. 5, Taiwan Patent Publication No. 514,766 dated Dec. 21, 2002 discloses a method for fabricating a mold core for a light guide plate. The method includes the following steps: coating a photo-resist layer on a substrate (step S801); exposing and developing the photo-resist layer to form a photo-resist pattern (step S802); forming a copper (Cu) layer on the photo-resist pattern and areas of the substrate not covered by the photo-resist pattern (step S803); electroforming a nickel (Ni) mold core on the Cu layer of the substrate (step S804); separating the substrate from the mold core having the Cu layer (step S805); and etching the Cu layer off from the mold core (step S806).

The above-described method requires that the copper layer be etched off after the electroforming has been completed. This makes the process unduly complex. In addition, the etching may be incomplete or may damage the underlying mold core. In such case, the final finished mold core does not accurately correspond to the photo-resist pattern.

It is desired to provide a method for fabricating a mold core which overcomes the above-described problems.

### SUMMARY OF THE INVENTION

Accordingly, an object of the present invention is to provide a mold core fabricating method which can readily yield a mold core having high precision.

In order to achieve the above-mentioned objective, a method of the present invention for fabricating a mold core comprises the following steps: mixing a silicone elastomer with a curing agent to form a mixture; defoaming bubbles of the mixture; forming a layer of the mixture on a substrate having a predetermined surface structure formed thereon; curing the layer of the mixture; and separating the cured layer from the substrate, thereby providing the mold core.

According to the present invention, there is no need for steps of forming a photo-resist pattern, forming a Cu layer, and/or etching the Cu layer off. Thus, the method has reduced complexity and cost compared with the method of the prior art. In addition, compared with the prior art, the final obtained structure of the mold core is more similar to the predetermined structure compared with that of the prior art. That is, the precision of the mold core is significantly increased.

Other objects, advantages and novel features of the present invention will be more apparent from the following detailed description of preferred embodiments thereof with reference to the attached drawings, in which:

### BRIEF DESCRIPTION OF THE DRAWINGS

FIG. 1 is a flow chart of a preferred method for fabricating a mold core, according to the present invention;

FIG. 2 is a schematic, side cross-sectional view of a substrate having a predetermined surface structure formed thereon, according to the method of the present invention;

FIG. 3 is similar to FIG. 2, but showing a layer of a mixture formed on the substrate;

FIG. 4 is similar to FIG. 3, but showing the layer separated from the substrate, the layer constituting the fabricated mold core; and

FIG. 5 is a flow chart of a conventional method for fabricating a mold core.

### DETAILED DESCRIPTION OF THE INVENTION

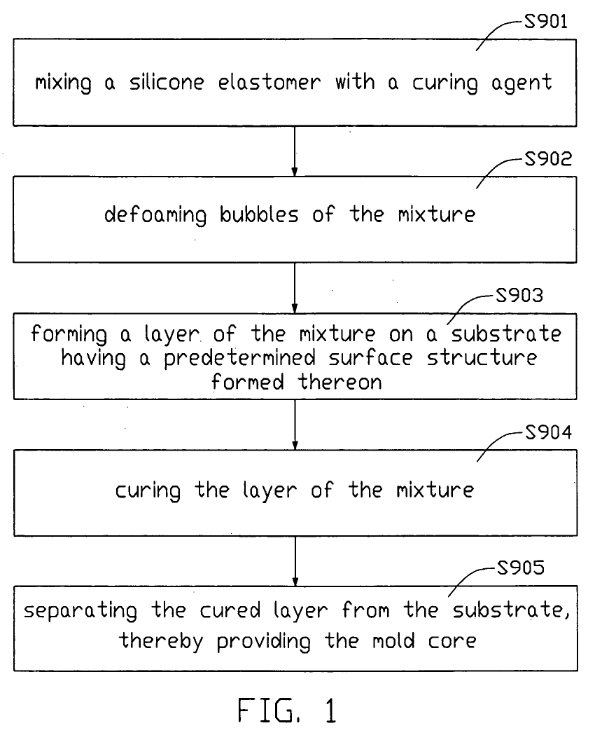

As shown in FIG. 1, a method for fabricating a mold core in accordance with the present invention includes the following steps: mixing a silicone elastomer with a curing agent to form a mixture (step S901); defoaming bubbles of the mixture (step S902); forming a layer of the mixture on a substrate having a predetermined surface structure formed thereon (step S903); curing the layer of the mixture (step S904); and separating the cured layer from the substrate, thereby providing the mold core (step S905).

In step S901, the silicone elastomer is polydimethyl siloxane, and the curing agent is an epoxy resin. A ratio by weight of the polydimethyl siloxane with respect to the epoxy resin is in the range from 5:1˜20:1, and preferably 10:1.

In step S902, the bubbles are defoamed in a vacuum environment, such as in a vacuum machine. The mixture is held at a working pressure of 0.05 torr or less, and at normal room temperature.

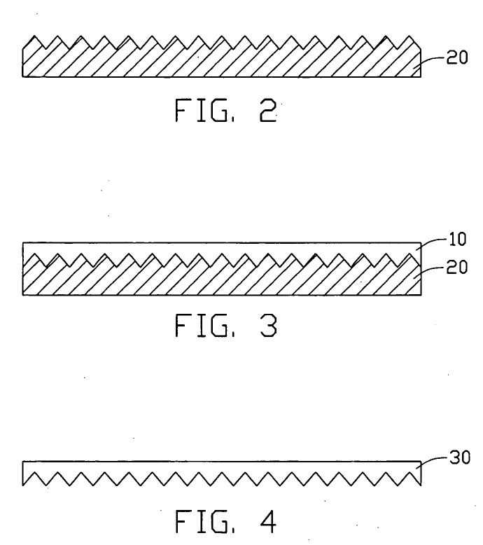

Referring also to FIGS. 2 and 3, in step S903, a substrate 20 having a plurality of V-shaped grooves (not labeled) preformed thereon is provided. The substrate 20 is made of a silicon wafer or a metal. Preferably, the substrate 20 is made of nickel (Ni). Forming the layer 10 of the mixture on the substrate 20 is performed in a vacuum environment, by way of spin-coating at a speed of 1000 rpm (revolutions per minute) or by way of spray-coating.

In step S904, the layer 10 is cured at a temperature between 80° C. and 120° C. for 4˜6 minutes, and preferably at a temperature of 100° C. for 5 minutes. Alternatively, the layer 10 can be cured at normal room temperature.

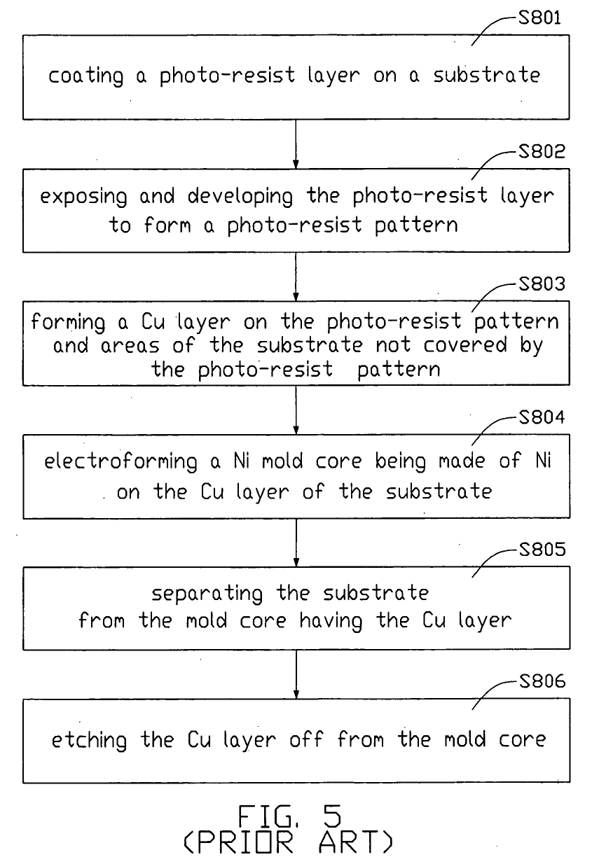

In step S905, the layer 10 is separated from the substrate 20. The desired mold core 30 is thus obtained, as shown in FIG. 4.

In summary, unlike in the prior art, there is no need for steps of forming a photo-resist pattern, forming a Cu layer, and/or etching the Cu layer off. Thus, the method of the present invention has reduced complexity and costs compared with the method of the prior art. In addition, the obtained structure of the mold core 30 corresponds more closely to the predetermined structure of the substrate 20, compared with the obtained structure of the mold core of the prior art. That is, the precision of the mold core 30 is significantly increased.

The method of the present invention can be used to manufacture a mold core for a light guide plate, an MEMS (micro-electro-mechanical system), or a biological chip.

It is to be understood that even though numerous characteristics and advantages of the present invention have been set out in the foregoing description, together with details of the steps and function of the invention, the disclosure is illustrative only, and changes may be made in detail, especially in matters of arrangement of steps within the principles of the invention to the full extent indicated by the broad general meaning of the terms in which the appended claims are expressed.

1. A method for fabricating a mold core, comprising:
mixing a silicone elastomer with a curing agent;
defoaming bubbles of the mixture;
forming a layer of the mixture on a substrate having a predetermined surface structure formed thereon;
curing the layer of the mixture; and
separating the cured layer from the substrate, thereby providing the mold core.

2. The method for fabricating a mold core as recited in claim 1, wherein a ratio by weight of the silicone elastomer with respect to the curing agent is in the range from 5:1˜20:1.

3. The method for fabricating a mold core as recited in claim 2, wherein the ratio by weight of the silicone elastomer with respect to the curing agent is 10:1.

4. The method for fabricating a mold core as recited in claim 1, wherein the substrate is a silicon wafer.

5. The method for fabricating a mold core as recited in claim 1, wherein the substrate is a metal.

6. The method for fabricating a mold core as recited in claim 5, wherein the metal comprises nickel.

7. The method for fabricating a mold core as recited in claim 1, wherein the silicone elastomer comprises polydimethyl siloxane.

8. The method for fabricating a mold core as recited in claim 1, wherein the curing agent comprises epoxy resin.

9. The method for fabricating a mold core as recited in claim 1, wherein the layer is spin-coated on the substrate.

10. The method for fabricating a mold core as recited in claim 9, wherein a speed of the spin-coating is approximately 1000 rpm.

11. The method for fabricating a mold core as recited in claim 1, wherein the layer is spray-coated on the substrate.

12. The method for fabricating a mold core as recited in claim 1, wherein the step of forming a layer of the mixture on the substrate is performed in a vacuum environment.

13. The method for fabricating a mold core as recited in claim 1, wherein the step of curing the layer is performed at a temperature between 80° C. and 120° C. for 4˜6 minutes.

14. The method for fabricating a mold core as recited in claim 13, wherein the step of curing the layer is performed at a temperature of about 100° C. for 5 minutes.

15. The method for fabricating a mold core as recited in claim 1, wherein the step of curing the layer is performed at normal room temperature.

16. A method for fabricating a mold, comprising the steps of:
providing a mixture of shapable material;
providing a substance with a predetermined surface structure thereon;
placing said mixture on said substance; and
hardening said mixture to form a complementary surface structure thereon with respect to said predetermined surface structure.

17. The method as recited in claim 16, wherein said mixture comprises silicone elastomer as said shapable material and a curing agent with a ratio of 5:1 to 20:1.

18. The method as recited in claim 16, further comprising the step of defoaming bubbles from said mixture before provision of said mixture.

19. A method for fabricating a mold, comprising the steps of:
providing a substance with a predetermined surface structure thereon;
placing a hardenable silicone elastomer on said substance to form a complementary surface structure thereon with respect to said predetermined surface structure; and
curing said silicone elastomer.

20. The method as recited in claim 19, further comprising the step of mixing said silicone elastomer with a curing agent without any foam therein before said placing step.
